(19) United States
(12) Patent Application Publication
(10) Pub. No.: US 2004/0079819 A1
(43) Pub. Date: Apr. 29, 2004

(54) Triple valve airlock-feeder

(75) Inventors: Michael M. Chen, Naperville, IL (US); Jianrong Chen, Naperville, IL (US); David M. Podmokly, Downers Grove, IL (US); David C. Wasz, Clarendon Hills, IL (US)

Correspondence Address: Alix, Yale & Ristas, LLP, 750 Main Street, Hartford, CT, 06103-2721, US

(73) Assignee: ALSTOM (Switzerland) Ltd.

(21) Appl. No.: 10/280,146

(22) Filed: Oct. 25, 2002

(51) Int. Cl. B02C 23/24

(52) U.S. Cl. 241/18

(57) ABSTRACT

An airlock-feeder for a coal pulverizing system which includes a raw coal bunker, a pulverizer, and a vertically extending coal duct forming a raw coal flow path from the raw coal bunker to the pulverizer. The airlock-feeder comprises upper, middle and lower, vertically separated valves disposed in the raw coal flow path. Each valve has a seal member, a disc pivotally mounted at a centerline, and a pneumatic actuator. At least one or two of the valves are closed at any given time thereby providing a positive air-tight seal.

### BACKGROUND OF THE INVENTION

This invention relates generally to apparatus and methods for supplying feed material to a pulverizer while preventing air infiltration into the pulverizer. More particularly, the present invention relates to airlock-feeder apparatus for supplying raw coal into~a coal pulverizer.

It has long been known in the prior art to provide apparatus for purposes of effecting the grinding or pulverizing of certain materials. More specifically, the prior art is replete with examples of various types of apparatus that have been used to effect such grinding of a multiplicity of materials. Coal is one such material wherein there is a need that it be ground to a particular fineness in order to render it suitable for the use in, for example, a fossil fuel(i.e., coal)-fired steam generating power plant.

For purposes of the discussion that follows, the coal-fired steam generating power plant referred to above is considered to consist of essentially the following major operating components: a raw coal bunker, an airlock-feeder, apparatus for pulverizing the coal, a distribution system for distributing the pulverized coal, and a furnace to which the pulverized coal is to be distributed. Of particular interest herein is that portion of the steam generating power plant known as the airlock-feeder.

One particular type of coal pulverizing apparatus which is to be found in the prior art is that which is most commonly known in the industry as a bowl mill. The bowl mill gets its name from the fact that the pulverization, i.e., the grinding of the coal to a particular fineness, is accomplished on a grinding surface that bears resemblance to a bowl. A bowl mill consists of essentially the following major operating components: a separator body in which the grinding table is mounted for rotation, a plurality of grinding rollers that cooperate interactively with the grinding table to effect the grinding of coal interposed therebetween, a coal supply means for supplying to the interior of the bowl mill the raw, untrammeled coal that is to be pulverized and an air supply means for supplying, also to the interior of the bowl mill, the air required for entrainment of pulverized coal of a certain fineness.

In accordance with the mode of operation of such a bowl mill, the coal, which is to be ground to a particular fineness, is introduced into the central portion of the bowl mill from above via a coal duct. The grinding rollers exert pressure against the grinding table and the coal trapped therebetween, thus effecting the pulverization of the coal. The grinding rollers are made to rotate by the mutual contact of the coal being pulverized with the grinding rollers and the rotating grinding table. Pressurized air, commonly known as primary air, is admitted to the lower portion of the separator body from beneath the grinding table so as to create an upwardly mobile stream of air flowing through and about the annular passage formed between the periphery of the grinding table and the inner wall of the separator body. The annular spaces cause the primary air stream to flow over the grinding table. The coal particles are thrown outwardly from the grinding table by the effect of centrifugal forces where particles of a certain fineness are entrained by the primary air stream. The coarsest coal particles are immediately returned to the grinding table to undergo further pulverizing action. The primary air stream continues to flow upwardly within the separator body, thence through a convoluted path that acts to further separate still relatively coarse coal particles from the primary air stream. Coal particles of a particular fineness remain entrained within the primary air stream and are carried through the remainder of the bowl mill. These particles finally exit the bowl mill and are delivered to the furnace of the steam generating power plant for combustion therein.

The airlock-feeder controls the flow of raw coal to the pulverizer and prevents the flow of air into the pulverizer via the coal duct. Air infiltration through the coal duct reduces the efficiency of the pulverizer, as the total air flow through the pulverizer is fixed and any infiltration into the middle of the pulverizer via the coal duct proportionally reduces the flow of air from the bottom of the pulverizer which is available to carry the ground coal from the grinding surface. In addition, air infiltration through the coal duct interferes with the classification process, leading to carryover of improperly sized coal particles and reducing removal of properly ground coal.

### SUMMARY OF THE INVENTION

Briefly stated, the invention in a preferred form is an airlock-feeder for a coal pulverizing system which includes a raw coal bunker, a pulverizer, and a vertically extending coal duct forming a raw coal flow path from the raw coal bunker to the pulverizer. The airlock-feeder comprises upper, middle and lower, vertically separated valves disposed in the raw coal flow path. Each valve has a seal member, a disc pivotally mounted at a centerline, and a pneumatic actuator.

In one embodiment, the seal member of the upper valve is composed of metal and the seal members of the middle and lower valves are inflatable. In another embodiment the seal members of the upper, middle and lower valves are inflatable.

Depending on the mode of operation, at least one or two of the valves are closed at any given time thereby providing a positive air-tight seal.

### BRIEF DESCRIPTION OF THE DRAWINGS

The present invention may be better understood and its numerous objects and advantages will become apparent to those skilled in the art by reference to the accompanying drawings in which:

FIG. 1a is a simplified schematic view of a conventional semi-direct fired coal pulverizing system and FIG. 1b is an enlarged view of the airlock-feeder of FIG. 1a;

FIG. 2 is a schematic view of an airlock-feeder in accordance with the invention;

FIG. 3 is an enlarged view of area III of FIG. 2;

FIG. 4 is an enlarged view of area IV of FIG. 2;

FIGS. 5a, 5b, and 5c are graphs of control schemes for the valves of FIG. 2; and

FIG. 6 is a front view of the airlock-feeder of FIG. 2.

### DETAILED DESCRIPTION OF THE PREFERRED EMBODIMENT

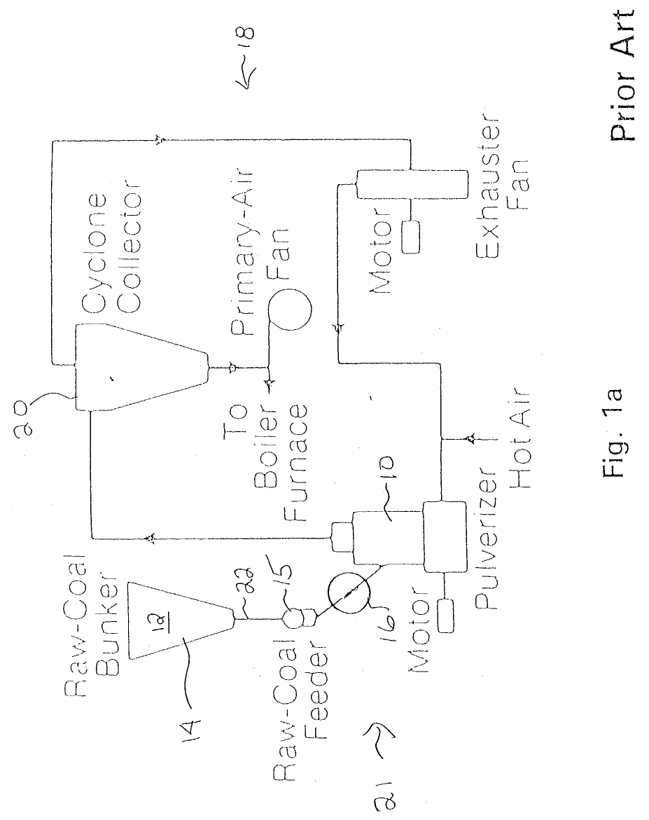

Coal pulverizers 10 of the type shown in FIG. 1a are used in modern coal-fired furnaces because pulverized coal burns substantially like gas and, therefore, fires are easily lighted and controlled. Pulverized coal furnaces can be readily adapted to burn all coal ranks from anthracite to lignite.

When in operation, raw coal 12 is from a raw coal bunker 14 to a pulverizer mill 10, such as a bowl mill, via a raw coal feeder 15 and an airlock-feeder 16. A distribution system 18, which ultimately delivers the pulverized coal to a furnace (not shown), may include a cyclone collector 20 and a storage bin (not shown), where pulverized coal is stored for later use. In the semi-direct fired boiler system 21 shown in FIG. 1a, a cyclone collector 20 located between the pulverizer 10 and the furnace separates the conveying medium from the coal. The coal is then fed directly from the cyclone collector 20 to the furnace in a primary air stream.

The airlock-feeder 16 controls the flow of raw coal to the pulverizer 10 and prevents the flow of air into the pulverizer 10 via the coal duct 22. Air infiltration through the coal duct 22 is limited to provide finer control of the combustion air provided to the furnace. In addition, some of the pulverizer mills 10 utilize an internal air flow to classify and remove the particles of coal which have been ground to the correct size. Air infiltration through the coal duct 22 interferes with the classification process, leading to carryover of improperly sized coal particles and reducing removal of the ground coal.

With reference to FIG. 1b, the conventional airlock-feeder 16 includes three gate valves 24, each of which includes a gate 26 which is pivotally mounted at one side of the coal duct 22. Hydraulic actuators 28 are required to operate the gates 26 due to the very high torque to open and close the gate 26. The coal duct 22 is either vertical or slanted slightly from the vertical to provide for gravity feed of the raw coal 12. Consequently, coal particles settle on the top surfaces of the gates 26. A portion of these coal particles adhere to the top surface or to coal particles which have adhered to the top surface. The coal particles adhered to the free end 30 of the gate 26 interfere with the seal between free end 30 and the coal duct 22, providing a leakage path 32 past the gate 26.

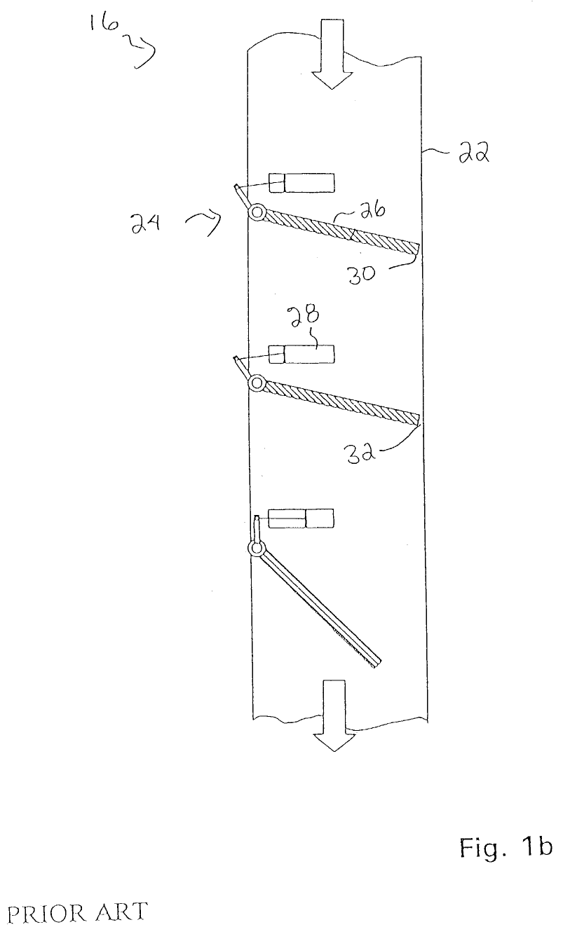

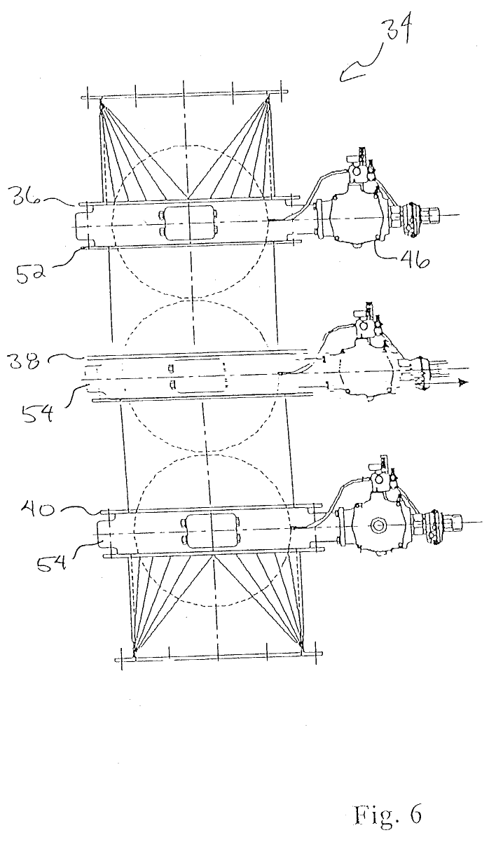

With reference to FIGS. 2 and 6, an airlock-feeder 34 in accordance with the invention includes three butterfly valves 36, 38, 40. Each valve 36, 38, 40 has a disc 42 which is pivotally mounted at its centerline 44 either within the coal duct 22 or between sections of the coal duct 22. Actuation of the disc 42 of such a valve 36, 38, 40 requires less than half of the torque than is required to actuate the gate 26 of the valves 24 of the conventional airlock-feeder 16, allowing the use of a pneumatic actuator 46. The pneumatic actuator 46 is less costly and more reliable compared to the hydraulic actuator 28 of the gate valves 24 of the conventional airlock-feeder 16. The middle and lower valves 38, 40 are Posiflate™ butterfly valves having a circumferential inflatable seal member 48. As described in U.S. Pat. No. 4,836,499 (Steele et al.), seal member 48 is inflated after the valve disc 42 is positioned in the “closed” position, thereby substantially preventing any leakage between the valve disc 42 and the seal member 48.

In a preferred embodiment, the upper valve 36 has a circumferential metal seal member 50, in place of the inflatable seal member 48 of the Posiflate™ valves 38, 40, providing a metal-to-metal seal between the disc 42 and the seal member 50. As the first valve in the flow path of the raw coal 12, the disc 42 of the upper valve 36 must close while raw coal is flowing through the valve 36. The disc 42 of upper valve 36 is always closed whenever the discs 42 of either the middle valve 38 or the lower valve 40 are required to close. That is, the volume of raw coal 12 sitting on top of the disc 42 of either the middle valve 38 or the lower valve 40 when such disc 42 begins to open, is fully exhausted through the valve 38, 40 before the disc 42 begins to close. Therefore, upper valve 36 is subject to a much greater abrasive action than are the middle and lower valves 38, 40. The metal seal member 50 is more resistant to wear and erosion due to abrasion by the passage of the raw coal 12. Further, the metal seal member 50 is not subject to failure due to puncture, whereas the ability of the Posiflate™ seal member 48 to inflate may be severely compromised if such a seal member is punctured.

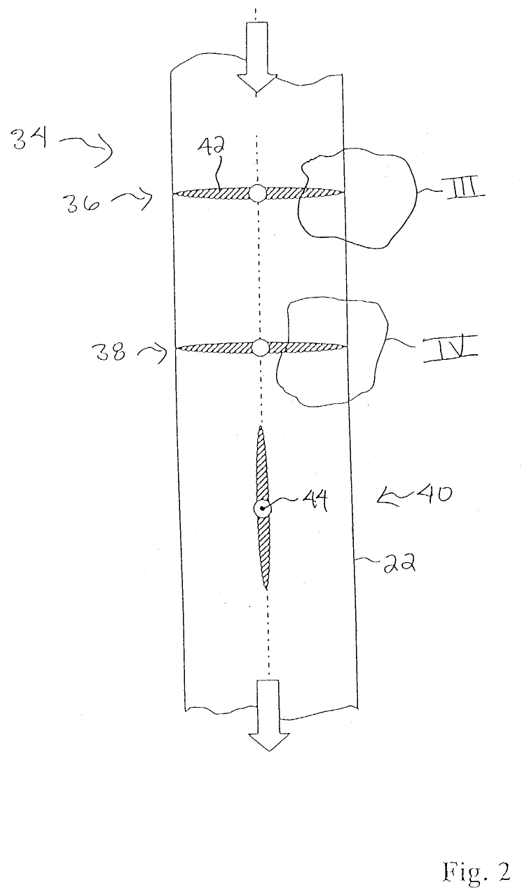

As further described in U.S. Pat. No. 4,836,499 (Steele et al.), the middle and lower valves 38, 40 may each include a circular housing 54 and disc 42. The housing 54 includes an air passage 56 for supplying the air used to inflate seal member 48. The housing 54 also includes an annular recess 58 for mounting seal member 48. Annular sealing ridges 78 seals against the adjacent portion of coal duct 22. The upper valve 36 also includes a circular housing 52, a disc 42 and the metal seal member 50. Housing 52 and seal member 50 may be of a unitary construction, as shown in FIG. 3.

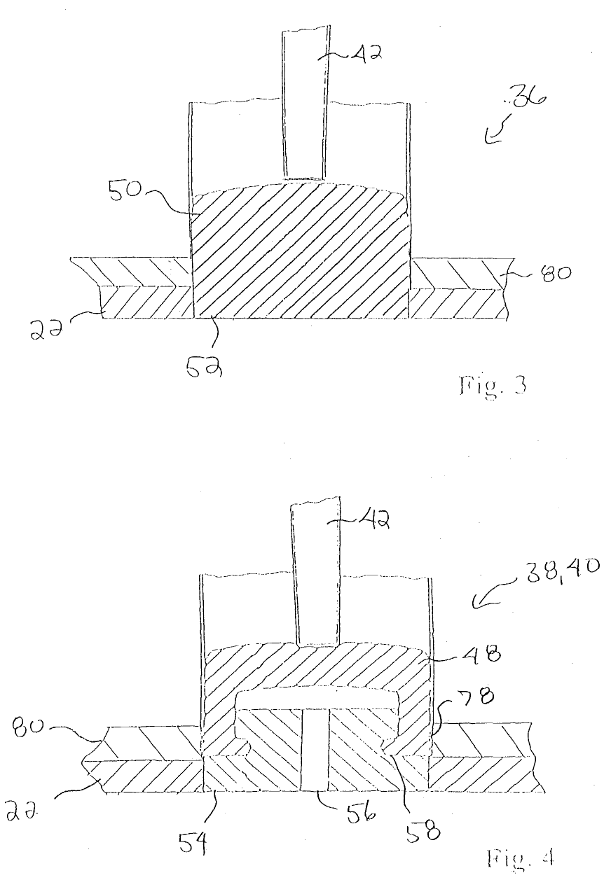

Preferably, a liner 80 composed of TIVAR™ material lines the inner surface of the coal duct 22 (FIGS. 3 and 4) from the raw coal bunker 14 to the airlock-feeder 34, between the valves 36, 38, 40 of the airlock-feeder 34, and from the airlock-feeder 34 to the pulverizer 10. While such material is generally used solely to reduce the wall friction opposing motion of solid materials, such as coal, along the wall, the TIVAR™ material is used in this application to also reduce adherence of coal particles to the wall of coal duct 22. This is especially important in the region of the coal duct 22 immediately adjacent to the valves 36, 38, 40 as accumulations of coal particles in this area could interfere with movement of the disc 42 or accelerate erosion of the disc 42.

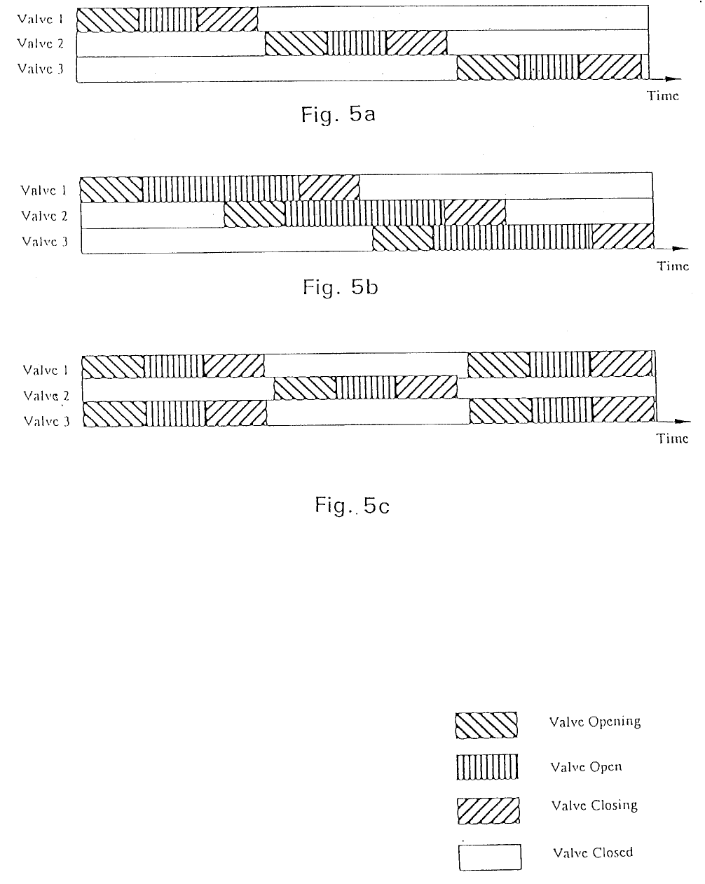

With reference to FIGS. 5a and 5c, the airlock-feeder 34 controls the raw coal feed rate by controlling the close/open time sequence of each of the valves 36, 38, 40. The three valve configuration provides variable feed control and requires less interruption time. Depending on the mode of operation, at least one or two valves are closed at any given time thereby providing a positive seal during operation of the boiler system 21.

In the control scheme of FIG. 5a (the “normal” mode), at least two of the valves are closed at all times. For example, the upper valve 36 (valve 1) completes the closing operation before the middle valve 38 (valve 2) begins the opening operation, where the closing operation includes inflation of the inflatable seal member 48 and the opening operation includes deflation of the inflatable seal member 48. Similarly, the middle valve 38 is closed completely before the lower valve 40 (valve 3) begins to open and the lower valve 40 is closed completely before the cycle repeats with the opening of the upper valve 36. To ensure that no two valves are even partially open at the same time, all valves 36, 38, 40 remain in the closed position for a predetermined period of time after the operation of each valve.

In the control scheme of FIG. 5c (the “maintenance” mode), at least one valve is closed at all times. In this scheme, the upper and lower valves 36, 40 begin opening at the same time and at the same rate, remain fully open for the same length of time, and begin closing at the same time and at the same rate. After both the upper and lower valves 36, 40 have been closed for a predetermined period of time, the middle valve 38 opens, remains open for a period of time, and closes. After the middle valve 38 has been closed for a predetermined period of time, the cycle repeats with both the upper and lower valves 36, 40 beginning to open. This mode can provide a higher feed rate than the “normal” mode if the valve open and close times are the same.

It should be appreciated that the airlock-feeder 34 may be temporarily operated in a two valve mode to allow one of the valves to be taken out of service for maintenance/repair. As a consequence, maintenance which will require placing the entire airlock-feeder 34 out of service will be required infrequently, providing for less interruption for the mill operation.

In an alternate embodiment, the upper valve 36 is another Posiflate™ butterfly valve. As discussed above, a butterfly valve having an inflatable seal member 48 may be used as the upper valve 36 where a metal-to-metal seal will not be sufficiently air-tight or in a boiler system 21 where the upper valve 36 is not expected to be exposed to greater abrasive wear than the middle or lower valves 38, 40.

The control scheme of FIG. 5b (the “overlap” mode) is preferably used only in the embodiment having an inflatable seal member 48 in the upper valve 36. In this control scheme, at least one valve is closed at all times. For example, both the middle and lower valves 38, 40 are closed as the upper valve 36 begins the opening operation. Each valve 36, 38, 40 remains open for an extended period of time, compared with the control scheme of FIG. 5a. While the upper valve 36 is fully open, the middle valve 38 begins to open. The upper valve 36 remains fully open for a predetermined period of time after the middle valve 38 becomes fully open and then closes while the middle valve 38 remains fully open. Similarly, the lower valve 40 begins to open while the middle valve 38 is open, the middle valve 38 remains open for a predetermined period of time after the lower valve 40 becomes fully open, the upper valve 36 begins to open while the lower valve 40 is open, and the lower valve 40 remains open for a predetermined period of time after the upper valve 36 becomes fully open. It should be appreciated that this scheme could be modified such that a preceding valve 36, 38, 40 begins the closing operation before a subsequent valve 38, 40, 36 begins the opening operation, with both the preceding and subsequent valves only being partially open at the same time. Conversely, the preceding valve 36, 38, 40 could remain open for a longer period of time after the subsequent valve 38, 40, 36 becomes fully open. To ensure that at least one valve is completely closed at all times, the upper valve 36 remains in the closed position for a predetermined period of time before the lower valve 40 begins to open, the middle valve 38 remains in the closed position for a predetermined period of time before the upper valve 36 begins to open, and the lower valve 40 remains in the closed position for a predetermined period of time before the middle valve 38 begins to open.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. An airlock-feeder for a coal pulverizing system including a raw coal bunker, a pulverizer, and a vertically extending coal duct, the coal duct defining a raw coal flow path from the raw coal bunker to the pulverizer, the airlock-feeder comprising:
an upper valve disposed in the raw coal flow path, the upper valve including a seal member, a disc pivotally mounted at a centerline, and a pneumatic actuator;
a middle valve disposed in the raw coal flow path at a distance below the upper valve, the middle valve including a seal member, a disc pivotally mounted at a centerline, and a pneumatic actuator; and
a lower valve disposed in the raw coal flow path at a distance below the middle valve, the lower valve including a seal member, a disc pivotally mounted at a centerline, and a pneumatic actuator.

2. The airlock-feeder of claim 1 wherein the seal member of the upper valve composed of metal and the seal members of the middle and lower valves are inflatable.

3. The airlock-feeder of claim 2 wherein the disc of each valve is composed of metal, the disc and seal member of the upper valve defining a metal-to-metal seal therebetween, the seal members of the middle and lower valves inflating and engaging the associated disc.

4. The airlock-feeder of claim 1 wherein the seal members of the upper, middle and lower valves are inflatable.

5. An airlock-feeder for a coal pulverizing system including a raw coal bunker, a pulverizer, and a vertically extending coal duct, the coal duct defining a raw coal flow path from the raw coal bunker to the pulverizer, the airlock-feeder comprising:
an upper valve disposed in the raw coal flow path the upper valve including a metal seal member and a disc pivotally mounted at a centerline;
a middle valve disposed in the raw coal flow path at a distance below the upper valve, the middle valve including an inflatable seal member and a disc pivotally mounted at a centerline; and
a lower valve disposed in the raw coal flow path at a distance below the middle valve, the lower valve including an inflatable seal member and a disc pivotally mounted at a centerline.

6. The airlock-feeder of claim 5 wherein each of the valves also includes a pneumatic actuator.

7. A coal pulverizing system comprising:
a raw coal bunker;
a pulverizer;
a vertically extending coal duct defining a raw coal flow path from the raw coal bunker to the pulverizer, the coal duct including an inner liner composed of a material having a low coefficient of friction; and
an airlock-feeder including
an upper valve disposed in the raw coal flow path, the upper valve having a seal member, a disc pivotally mounted at a centerline, and a pneumatic actuator,
a middle valve disposed in the raw coal flow path at a distance below the upper valve, the middle valve having a seal member, a disc pivotally mounted at a centerline, and a pneumatic actuator, and
a lower valve disposed in the raw coal flow path at a distance below the middle valve, the lower valve having a seal member, a disc pivotally mounted at a centerline, and a pneumatic actuator.

8. The coal pulverizing system of claim 7 wherein the liner of the coal duct is composed of TIVAR™ material.

9. A method of feeding raw coal from a raw coal bunker to a pulverizer via a vertically extending coal duct, the coal duct including an airlock-feeder having upper, middle and lower, vertically spaced valves, each of the valves having a disc and a seal member, each disc being rotatable about a centerline between open and closed positions, the associated seal member and disc forming a substantially air-tight seal when the disc is in the closed position, the method comprising the steps of:
(a) verifying the discs of the middle and lower valves are each in the closed position;
(b) rotating the disc of the upper valve from the closed position to the open position, whereby raw coal drops from the raw coal bunker into a section of the coal duct disposed intermediate the upper and middle valves;
(c) rotating the disc of the upper valve from the open position to the closed position;
(d) rotating the disc of the middle valve from the closed position to the open position, whereby raw coal drops from the section of the coal duct disposed intermediate the upper and middle valves into a section of the coal duct disposed intermediate the middle and lower valves;
(e) rotating the disc of the middle valve from the open position to the closed position;
(f) rotating the disc of the lower valve from the closed position to the open position, whereby raw coal drops from the section of the coal duct disposed intermediate the middle and lower valves into the pulverizer;
(g) rotating the disc of the lower valve from the open position to the closed position; and
(h) repeating steps (b)-(g).

10. A method of feeding raw coal from a raw coal bunker to a pulverizer via a vertically extending coal duct, the coal duct including an airlock-feeder having upper, middle and lower, vertically spaced valves, each of the valves having a disc and a seal member, each disc being rotatable about a centerline between open and closed positions, the associated seal member and disc forming a substantially air-tight seal when the disc is in the closed position, the method comprising the steps of:
(a) verifying the disc of the middle valve is in the closed position;
(b) rotating the discs of the upper and lower valves from the closed position to the open position, whereby raw coal drops from the raw coal bunker into a section of the coal duct disposed intermediate the upper and middle valves and raw coal drops from the section of the coal duct disposed intermediate the middle and lower valves into the pulverizer;
(c) rotating the discs of the upper and lower valves from the open position to the closed position;
(d) rotating the disc of the middle valve from the closed position to the open position, whereby raw coal drops from the section of the coal duct disposed intermediate the upper and middle valves into a section of the coal duct disposed intermediate the middle and lower valves;
(e) repeating steps (b)-(d).

11. A method of feeding raw coal from a raw coal bunker to a pulverizer via a vertically extending coal duct, the coal duct including an airlock-feeder having upper, middle and lower, vertically spaced valves, each of the valves having a disc and a seal member, each disc being rotatable about a centerline between open and closed positions, the associated seal member and disc forming a substantially air-tight seal when the disc is in the closed position, the method comprising the steps of:
(a) verifying the disc of the middle valve is in the closed position;
(b) rotating the disc of the upper valve from the closed position to the open position, whereby raw coal drops from the raw coal bunker into a section of the coal duct disposed intermediate the upper and middle valves;
(c) rotating the disc of the lower valve from the open position to the closed position;
(d) rotating the disc of the middle valve from the closed position to the open position, whereby raw coal drops from the section of the coal duct disposed intermediate the upper and middle valves into a section of the coal duct disposed intermediate the middle and lower valves;
(e) rotating the disc of the upper valve from the open position to the closed position;
(f) rotating the disc of the lower valve from the closed position to the open position, whereby raw coal drops from the section of the coal duct disposed intermediate the middle and lower valves into the pulverizer;
(g) rotating the disc of the middle valve from the open position to the closed position;
(h) repeating steps (b)-(g).
